(19) United States
(12) Patent Application Publication
(10) Pub. No.: US 2010/0147648 A1
(43) Pub. Date: Jun. 17, 2010

(54) LOAD-BEARING STRUCTURE FOR PEOPLE AND/OR GOODS TRANSPORT SYSTEMS

(75) Inventors: Miguel Angel Gonzalez Alemany, Oviedo (ES); Monica Diaz Sorribas, Gijon (ES); Antonio Murias Bermejo, Gijon (ES); Marcos Vega Lopez, Oviedo (ES)

Correspondence Address: MERCHANT & GOULD PC, P.O. BOX 2903, MINNEAPOLIS, MN, 55402-0903, US

(73) Assignees: THYSSENKRUPP ELEVATOR INNOVATION CENTER, S.A., Gijon (ES); THYSSENKRUPP ELEVATOR (ES/PBB) GmbH, Essen (DE)

(21) Appl. No.: 12/636,597

(22) Filed: Dec. 11, 2009

(30) Foreign Application Priority Data
Dec. 12, 2008 (ES) 200803533

(51) Int. Cl. B66B 21/10; B66B 23/08; B66B 23/24; B66B 23/22

(52) U.S. Cl. 198/335; 198/321

(57) ABSTRACT

Load-bearing structure of a people and/or goods transport system, comprising a mobile band, blades/rungs containing a roller; two side beams; a central body in the form of a sheet having: an upper connection surface to connect the side beams through connection elements; a lower sealing surface parallel to the upper connection surface, at a level below the upper connection surface, to define a closure of the load-bearing structure. The two side beams have a lower connection surface to connect with the central body through connection elements.

This application claims benefit of Ser. No. 200803533, filed 12 Dec. 2008 in Spain and which application is incorporated herein by reference. To the extent appropriate, a claim of priority is made to the above disclosed application.

### FIELD OF THE INVENTION

The present invention refers to the load-bearing structure of a people and/or goods transport system, comprising a mobile band and upper and lower fixed plates for loading and unloading. The mobile band comprises a plurality of elements which run between lateral guides and railing with handrail.

### BACKGROUND OF THE INVENTION

The moving walkway appears as an evolution of the escalator, enabling to use wheeled devices, such as shopping carts, trolleys, prams or vehicles for the disabled, whose transport is not possible in an escalator. This kind of moving walkways, as well as escalators, generally have a structure where the rolling profiles are fixed, on which the blades or rungs of the moving walkable surface roll and where, in turn, the railings with handrails and the dragging and overturn mechanisms are fixed.

The load-bearing structure in conventional passenger transport systems, such as escalators or moving walkways, in its traditional conception, is usually a welded metallic structure formed by two lattices, the members of which are laminated profiles, joined together by transverse elements which increase their rigidity. On each lattice, there are mounted screwed profiles, which serve as a guide for the movement of the blades or rungs forming the tread, as well as all the mechanical and electric elements needed for its operation.

The use of two lattices forces to close the hole between them to avoid the falling of particles and drops coming from the rolling surface or from the mechanisms and their elements, for which there is on the lower part a horizontal sealing plate which has to be welded in a watertight manner to the lower curbs of the side lattices in its entire length. Other alternatives include sealing also with lattice in the lower part, on which a series of trays rest.

Additionally, it is necessary to mount an outer coating which laterally covers said lattices to avoid the access of the public to the inside of the structure. The dimensions of the structure section have to be such that they provide enough space to house the band of blades or rungs in its way back, which in certain occasions makes the resulting structure larger than really needed to save the opening from the structural point of view. This entails a need for a minimum mounting space which in certain cases conditions the height of the installation.

### DESCRIPTION OF THE INVENTION

The present invention refers to a passenger and/or goods transport system comprising a main mobile band and lower and upper fixed plates for loading and unloading. The mobile band circulates along a guidance system and said band is activated by an appropriate power transmission system, being laterally limited by two railings on which handrails circulate at the same speed as the mobile band; and with the appropriate control and safety systems for a correct system operation. More specifically, the present invention is characterized in that the load-bearing structure of the walkway or escalator is a beam comprising two close section profiles longitudinally joined to the ends of a folded sealing sheet with a U-shaped section, and being joined together by a series of elements with a transverse arrangement which increase its torsional rigidity.

In a preferred configuration, the metallic profiles are formed in such a way that, besides fulfilling a structural function, they provide the vertical and horizontal guidance for the movement of the blades or rungs of the ball race, in such a way that the mounting process is simplified.

In a preferred configuration, the load-bearing metallic profile serves as a support and fixing base for the railing with handrail and the bedplate. The folded sheet also serves as a closure for the whole assembly, providing the necessary watertightness, under the ball race. Said folded sheet makes it unnecessary to install a rear closing coating, although other configurations are possible where additional coatings are added for ornamental purposes.

Other configurations are also possible in which the ball race of the blades or rungs does not form an intrinsic part of the metallic profile with a resistant sealing closed section, instead, the ball races are independent and are incorporated to it by an adjustable union.

According to an embodiment, the load-bearing metallic profiles are integral to the folded closing sheet through a riveted union in an appropriate arrangement to ensure the effort transmission between them. Other embodiments using welded, screwed-in, adhesive unions or combinations thereof are also possible. With the embodiment described, the system of the invention presents the following advantages:
It reduces the space occupied by the load-bearing structure of the walkway or escalator in the place of installation.
It eliminates the need of installing a sealing sheet in the lower part of the structure and of ensuring its watertightness.
It considerably simplifies the process of manufacturing, mounting and adjustment of the assembly.
It saves space and facilitates handling during its manufacturing, storage and transportation. Particularly, the lower sealing sheet of the structure is formed in such a way that its stacking is possible, being able to store several units, which are nested one on top of the other and allowing the maximum space saving.

### BRIEF DESCRIPTION OF THE DRAWINGS

In the attached drawings an example of a non-limiting embodiment is described, in which:

FIG. 1 is a general view of an inclined walkway, according to the current state of the art, in which the load-bearing structure with lattice sides is appreciated, a partial view of the surface of blades of the mobile band and one of the railings with handrails.

FIG. 2 is a section, on a perpendicular plane to the ball race direction, of the structure and position on it of several components of the walkway, such as blades, guidance profiles, railing and bedplate.

FIG. 3 is a general view of the walkway inclined with a compact load-bearing structure, where it is appreciated the relative position of the blade band and the railing with handrail and bedplate.

FIG. 4 is a sectional view, on a perpendicular plane to the ball race direction of an inclined walkway with a compact load-bearing structure, where it is appreciated the load-bearing beam formed by two lateral profiles and a sealing sheet. It is also appreciated the relative position of the ball race elements and the railing with handrail.

FIG. 4A is a detailed view of FIG. 4. It shows the forward or upper and back or lower ball races with the retaining surfaces. It also shows the connection means and union means.

FIG. 5 shows a load-bearing structure having second side beams.

### DETAILED DESCRIPION OF AN EMBODIMENT

The characteristics and advantages of the system of the invention will be understood better with the following description of a non-limiting embodiment, shown in the aforementioned drawings.

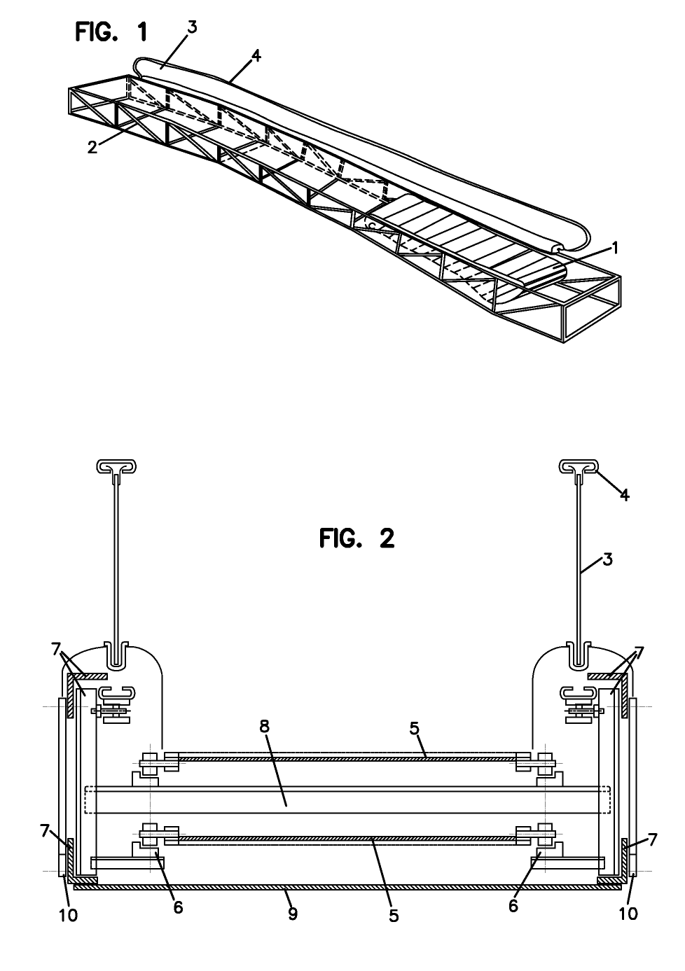

FIGS. 1 and 2 show the constitution of an inclined walkway according to the current state-of-the-art, comprising a mobile band 1 which runs on a load-bearing structure 2 and between railings 3 with handrail 4. The mobile band comprises blades 5 rolling on rolling guides 6 which are in turn mounted on a load-bearing structure 2.

In the walkway shown in FIGS. 1 and 2 the load-bearing structure comprises two side beams in the form of lattice comprising laminated metallic profiles 7 welded to one another. Said side beams are joined together through laminated profiles 8 arranged perpendicularly to its plane and through a metallic sealing sheet 9 joined to the lower members of the lattices through watertight welding.

On each one of the side beams there are coating plates 10 all along them, so that access to the interior of the load-bearing structure through the lattices is closed. On the upper members of the lattices the railings with handrail are fixed through an adjustable screwed-in union.

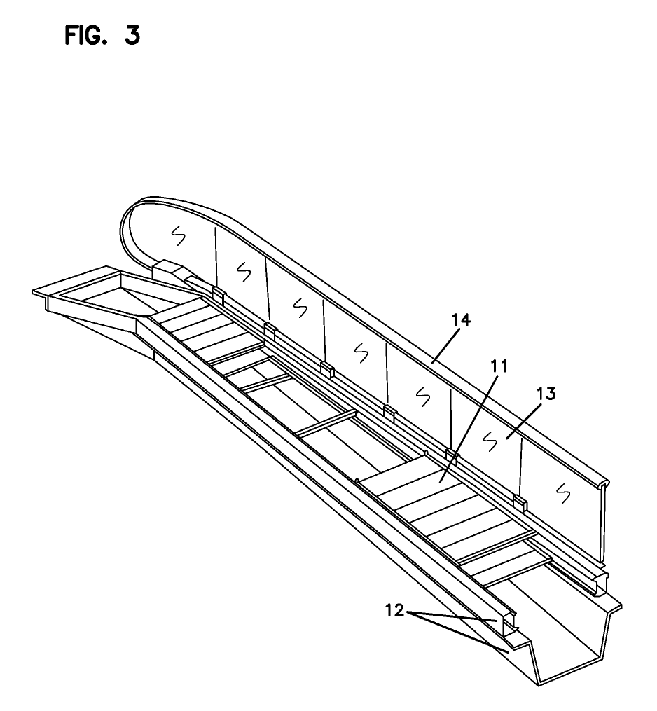

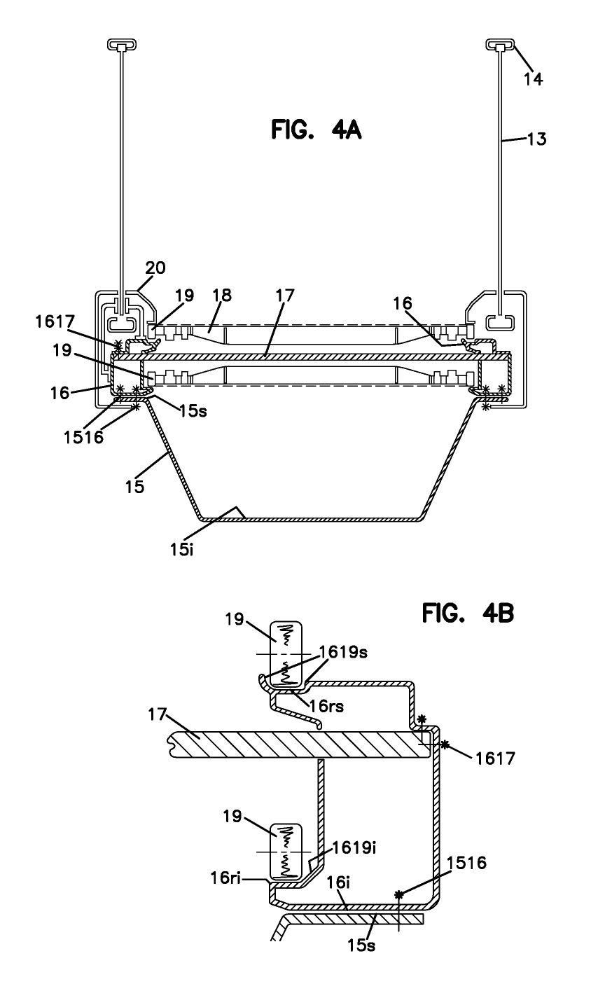

FIGS. 3 and 4 show a ramp for the transport of people and/or goods with the constitution of the present invention.

According to the invention, the load-bearing structure 12 of the walkway is a beam constituted by a central body 15 and two side profiles 16. The central body comprises a sole metallic sheet formed in such a way that on its upper part two side profiles can rest. Said side profiles are sealed metallic profiles with thin walls and configured in such a way that the rollers 19 of the mobile band 11 blades 18 can roll directly on them and they can be guided in the direction perpendicular to the movement direction.

The side profiles are rigidly joined between them through a series of assembling elements 17 the axis of which is in a plane parallel to the surface or mobile band 11. Additionally, said side profiles are rigidly joined to the central body in longitudinal direction so that complete rigidity of the beam is guaranteed, for example, through a union of rivets arranged in such a way that they can transmit the efforts from the mobile band during its use, and from the weight of all the accessories.

According to the invention, the assembly of the structure provides the necessary rigidity for the installation, being it possible to increase (or reduce), in a simple manner, said rigidity according to the shape given to the sheet of the central body, according to the needs of installation. In turn, the shape of this sealing sheet makes unnecessary the watertight union between the side profiles and the central body, since, on the one hand, it acts as a king of container, and on the other hand, it makes possible the stocking of one on top of the other, in order to reduce to a minimum the space required for transport and storage.

In turn, the side profiles serve as support for the railings 13 with handrail 14, and for the bedplates 20.

Thus, an embodiment of the invention refers to a load-bearing structure for people and/or goods transport systems, having:
1a) a mobile band 11, comprising the mobile band 11 a plurality of blades/rungs 18 containing rollers 19 configured to slide between lateral guides;
1b) two side beams 16 arranged symmetrically to the half longitudinal plane perpendicular to a mobile band 11;

characterized in that:
1c) it comprises a central body (15) in the form of a sheet comprising:
   1c1) an upper connection surface 15s configured to connect with the side beams 16 through connection means 1516;
   1c2) a lower sealing surface 15i parallel to the upper connection surface 15s, at a level under the upper connection surface 15s, configured to define a closure of the load-bearing structure;
1d) the two side beams 16 comprise a lower connection surface 16i configured to connect with the central body 15 through connection means 1516.

According to other characteristics of the invention:

2) The load-bearing structure:
2a) also comprises at least a union cross member 17 in a plane parallel to the mobile band 11 to join the side beams 16 and form a load-bearing structure 12 with greater rigidity;
2b) the side beams 16 comprise a union surface 16u configured to join with the union cross member 17 through union means 1617.
3a) The beams 16 comprise:
   3a1) a surface comprising the first forward rolling way 16rs on which the rollers 19 roll;
   3a2) a surface comprising the first backward rolling way 16ri on which the rollers 19 roll;
3b) at least one of the two beams 16 comprises at least a first retaining surface 1619s, 1619i forming a 90° angle, with at least one of the two first rolling paths 16rs, 16ri, in at least one lateral roller 19, to prevent the transverse displacement of the blades/rungs 18. FIG. 4A shows the two alternatives: the surface like a curb on one or both sides of the roller 19.

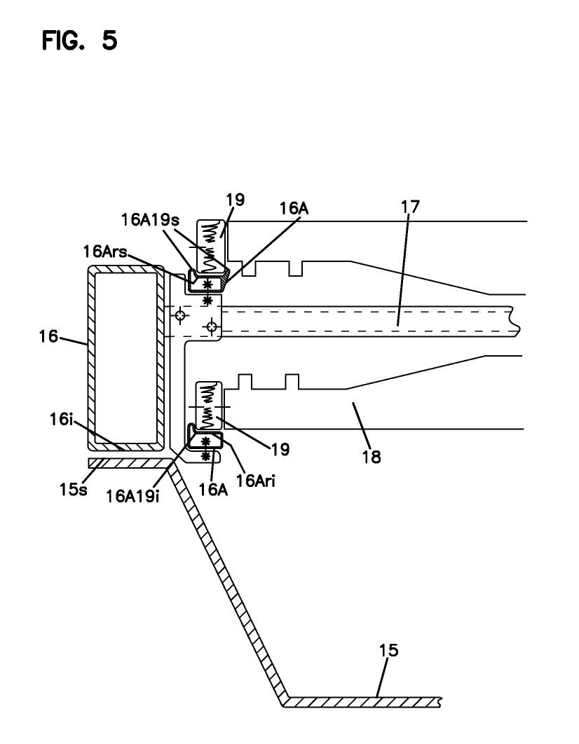

4) The load-bearing structure comprises second side beams 16A:
4a) independently mounted on each side beam 16;
4b) configured to constitute support means and guidance of blades/rungs 18;
4c) comprising:
   4c1) a surface comprising a second forward rolling path 16Ars on which the rollers 19 run;
   4c2) a surface comprising a second backward rolling path 16Ari on which the rollers 19 run;
4d) at least one of the beams 16A comprises at least a second retaining surface 16A19s, 16a19i forming a ≧90° angle, with at least one of the two second rolling paths 16Ars, 16Ari, in at least a side of the roller 19, to avoid a transverse displacement of the blades/rungs 18. FIG. 5 shows the two alternatives: the surface like a curb on one or both sides of the roller 19.

5) The connection means 1516 are selected between riveted connections, screwed connections.

6) The central body 15 comprises a simple beam formed by at least a metallic sheet configured to allow a stocking of a plurality of load-bearing structures 12 resting on one another.

7) The central body 15 comprises a beam formed by a lattice structure.

8) The load-bearing structure also comprises a railing 13 having a handrail 14 and a bedplate 20 on each side profile 16 to laterally limit the mobile band 11.

9) The central body 15 has a trapezoid-like transverse section.

1. Load-bearing structure for people and/or goods transport system having:
1a) a mobile band, comprising said mobile band a plurality of blades/rungs containing rollers configured to slide between lateral guides;
1b) two side beams arranged symmetrically to the half longitudinal plane perpendicular to a mobile band wherein:
1c) it comprises a central body in the form of a sheet comprising:
1c1) an upper connection surface configured to connect with the side beams through connection means;
1c2) a lower sealing surface parallel to the upper connection surface, at a level under the upper connection surface, configured to define a closure of the load-bearing structure;
1d) the two side beams comprise a lower connection surface configured to connect with the central body through connection means.

2. Load-bearing structure for people and/or goods transport system according to claim 1, wherein:
2a) it also comprises at least a union cross member in a plane parallel to the mobile band to join the side beams and form a load-bearing structure with greater rigidity;
2b) the side beams comprise a union surface configured to join with the union cross member through union means.

3. Load-bearing structure for people and/or goods transport system according to claim 1, wherein:
3a) the beams comprise:
3a1) a surface comprising the first forward rolling path on which the rollers roll;
3a2) a surface comprising the first backward rolling way on which the rollers roll;
3b) at least one of the two beams comprises at least a first retaining surface forming a ≧90° angle, with at least one of the two first rolling paths, in at least one lateral roller, to prevent the transverse displacement of the blades/rungs.

4. Load-bearing structure for people and/or goods transport system according to claim 1, wherein it comprises second side beams:
4a) independently mounted on each side beam;
4b) configured to constitute support means and guidance of blades/rungs;
4c) comprising:
4c1) a surface comprising a second forward rolling path on which the rollers run;
4c2) a surface comprising a second backward rolling path on which the rollers run;
4d) at least one of the beams comprises at least a second retaining surface forming a ≧90° angle, with at least one of the two second rolling paths, in at least a side of the roller, to avoid a transverse displacement of the blades/rungs.

5. Load-bearing structure for people and/or goods transport system according to claim 1, wherein the connection means are selected between riveted connections, screwed connections.

6. Load-bearing structure for people and/or goods transport system according to claim 1, wherein the central body comprises a simple beam formed by at least a sheet configured to allow a stocking of a plurality of load-bearing structures resting on one another.

7. Load-bearing structure for people and/or goods transport system according to claim 1, wherein the central body comprises a beam formed by a lattice structure.

8. Load-bearing structure for people and/or goods transport system according to claim 1, wherein it also comprises
a railing having a handrail and a bedplate on each side profile to laterally limit the mobile band.

9. Load-bearing structure for people and/or goods transport system according to claim 1, wherein the central body has a trapezoid-like transverse section.
